(19) United States
(12) Patent Application Publication
(10) Pub. No.: US 2026/0320651 A1
(43) Pub. Date: Oct. 15, 2026

(54) SYSTEM AND METHOD FOR AUTOMATICALLY GENERATING OPTIMAL MESSAGE FOR EACH CUSTOMER IN MULTI-CAMPAIGN ENVIRONMENT

(71) Applicant: DATARIZE INC., Seoul (KR)

(72) Inventors: Seong Moo KIM, Seoul (KR); Gyu Min LEE, Seoul (KR); Min Sung PARK, Seoul (KR)

(21) Appl. No.: 19/691,486

(22) Filed: May 28, 2026

Related U.S. Application Data
(63) Continuation of application No. PCT/KR2023/021375, filed on Dec. 22, 2023.

(30) Foreign Application Priority Data
Dec. 5, 2023 (KR) 10-2023-0174031

(51) Int. Cl. G06Q 30/0251; G06Q 30/0242

(52) U.S. Cl. CPC G06Q 30/0269; G06Q 30/0242; G06Q 30/0255

(57) ABSTRACT

According to an embodiment of the present disclosure, a system for automatically generating an optimal message for each customer in a multi-campaign environment may include: a profiling processing module configured to generate profiling based on behavioral data on a browser and metadata of a customer company; a scenario processing module configured to generate a plurality of scenario data based on result data of the generated profiling; a scenario selection module configured to select final data for each individual from among the plurality of scenario data; and a transmission processing module configured to transmit a message to each individual by each channel based on the selected final data for each individual.

### CROSS-REFERENCE TO RELATED APPLICATION

This application is a U.S. Bypass Continuation Application of International Application No. PCT/KR2023/021375, filed on Dec. 22, 2023, which claims priority to and the benefit of Korean Patent Application No. 10-2023-0174031, filed on Dec. 5, 2023, the disclosure of which is incorporated herein by reference in its entirety.

### BACKGROUND

### Technical Field

The present disclosure relates to a message generation system and method, and more particularly, to a system and method for automatically generating and transmitting an optimal message for each customer in a multi-campaign environment.

### Background Art

Many companies operating commerce services send emails, text messages, KakaoTalk channel messages, app push notifications, and the like for CRM (customer relationship management) purposes in order to increase the purchase conversion rate and average order value of existing members. In order to send messages, it is necessary to configure a campaign based on the five Ws and one H.

For example, in order to send a message, it is necessary to set conditions for targeted recipients who will receive the message, and it is necessary to set a date and time at which the message will be sent. In addition, in order to send a message, it is necessary to set a channel through which the message will be sent (for example, email, text message, messenger (Alimtalk and Friendtalk (KakaoTalk channels)), app push notification, or the like), and it is necessary to set text, an image, a button name, a button link, and the like included in the message (creative). In addition, in order to send a message, a target metric indicating which quantitative metric is to be achieved by sending the message should be set, and other conditions, such as how many messages are allowed to be sent to one person per day, should be set.

Message performance may basically be evaluated through four metrics, i.e., visit rate, click-through rate, purchase conversion rate, and ROAS, after a campaign is created by setting all of the five Ws and one H and the message is sent. In order to further improve performance, a method called A/B testing is mainly used, in which approximately one of the five Ws and one H is changed and the message is sent, and, for example, the four metrics of Group A and Group B may be compared. Meanwhile, although such A/B testing is an excellent method for optimizing message performance, it is cumbersome in that a marketer must manually configure the settings each time, conduct the experiment, and perform subsequent analysis. In addition, if the number of message transmissions is not large, only a single variation may be tested in one experiment, and thus a long period of time may be required until optimization is achieved.

Accordingly, there is a need for a method capable of generating and transmitting a message optimized for each customer within a short period of time with only a simple setting.

### SUMMARY

### Technical Problem

An object of the present disclosure is to provide a system and method for automatically generating an optimal message for each customer in a multi-campaign environment, capable of automatically generating an optimized message with only a few simple settings by a marketer.

### Technical Solution

According to an embodiment of the present disclosure, a system for automatically generating an optimal message for each customer in a multi-campaign environment may include: a profiling processing module configured to generate profiling based on behavioral data on a browser and metadata of a customer company; a scenario processing module configured to generate a plurality of scenario data based on result data of the generated profiling; a scenario selection module configured to select final data for each individual from among the plurality of scenario data; and a transmission processing module configured to transmit a message to the each individual by each channel based on the selected final data for each individual.

The behavioral data on the browser may include at least one of a page uniform resource locator (URL), an item exposure count, cart information, purchase information, and scroll information.

The metadata of the customer company may include at least one of purchase history, member information, and promotion information.

The profiling may include at least one of an interest level in a specific item, an interest level in a specific category, a purchase probability, and a revisit probability.

The scenario processing module may include a triggering module configured to trigger simultaneous processing of batch data generation for scenario data and real-time requests for scenario data.

The scenario processing module may include a scenario matching module configured to select a target scenario based on a campaign execution status of the customer company, individual profiling, and performance data.

The scenario processing module may include a scenario generation module configured to generate a plurality of scenario data for each individual.

The scenario processing module may include a supplemental information processing module configured to additionally generate supplemental information to be mandatorily included in a campaign.

The scenario selection module may include: a priority evaluation module configured to sort scenario data based on priority information derived from past campaign performance of the customer company; a channel filtering module configured to remove unnecessary data based on a channel status for each customer company; and a content selection module configured to select one of scenario data from the filtered plurality of scenario data.

The system may further include a performance measurement module configured to collect different feedback data according to characteristics of each channel and measure performance of a campaign.

According to an embodiment of the present disclosure, a method for automatically generating an optimal message for each customer in a multi-campaign environment may include: generating profiling based on behavioral data on a browser and metadata of a customer company; generating a plurality of scenario data based on result data of the generated profiling; selecting final data for each individual from among the plurality of scenario data; and transmitting a message to each individual by each channel based on the selected final data for each individual and for each channel.

The behavioral data on the browser may include at least one of a page uniform resource locator (URL), an item exposure count, cart information, purchase information, and scroll information.

The metadata of the customer company may include at least one of purchase history, member information, and promotion information.

The profiling may include at least one of an interest level in a specific item, an interest level in a specific category, a purchase probability, and a revisit probability.

Generating the scenario data may include triggering simultaneous processing of batch data generation for scenario data and real-time requests for scenario data.

### Advantageous Effects

According to the present disclosure, there is an advantage in that an optimized message can be automatically generated and transmitted with only a few simple settings by a marketer, without the need to experiment with, measure, determine, and adjust all of the elements corresponding to the above-described five Ws and one H.

According to the present disclosure, there is an advantage in that an optimized message can be automatically generated and transmitted with only a few simple settings by a marketer, without the need to experiment with, measure, determine, and adjust all of the elements corresponding to the above-described five Ws and one H. For example, there is an advantage in that, when a marketer inputs only simple settings, an item of interest may be estimated for each member, and creative content (for example, an image, text, or the like) may be automatically generated and transmitted.

### BRIEF DESCRIPTION OF THE DRAWINGS

FIG. 1 is a block diagram illustrating a detailed configuration of a system for automatically generating an optimal message for each customer in a multi-campaign environment according to an embodiment of the present disclosure.

FIG. 2 is a block diagram illustrating a detailed configuration of a scenario processing module according to an embodiment of the present disclosure.

FIG. 3 is a block diagram illustrating a detailed configuration of a scenario selection module according to an embodiment of the present disclosure.

FIG. 4 is a flowchart illustrating a method for automatically generating an optimal message for each customer in a multi-campaign environment according to an embodiment of the present disclosure.

FIG. 5 is a block diagram illustrating a system for automatically generating an optimal message for each customer in a multi-campaign environment according to an embodiment of the present disclosure.

### DETAILED DESCRIPTION

Embodiments of the present disclosure will now be described in detail with reference to the accompanying drawings. However, the present disclosure is not limited or restricted to the embodiments.

Terms used herein are for describing the embodiments and are not intended to limit the present disclosure. As used herein, singular forms also include plural forms unless the context clearly indicates otherwise. As used herein, the terms “comprises” and/or “comprising” do not preclude the presence or addition of one or more other elements, steps, operations, and/or devices in addition to the stated elements, steps, operations, and/or devices.

As used herein, terms such as “embodiment,” “example,” “aspect,” and “illustration” are not to be construed as indicating that any described aspect or design is superior to or advantageous over other aspects or designs.

Further, the term “or” is intended to mean an inclusive or rather than an exclusive or. That is, unless otherwise stated or unless clear from the context, the expression “x uses a or b” means any one of the natural inclusive permutations.

Further, as used herein and in the claims, a singular expression (“a” or “an”) should generally be construed to mean “one or more” unless otherwise stated or unless it is clear from the context that the expression is directed to a singular form.

Further, as used herein and in the claims, terms such as “first” and “second” may be used to describe various elements, but the elements should not be limited by such terms. Such terms are used only for the purpose of distinguishing one element from another element.

Unless otherwise defined, all terms used herein, including technical and scientific terms, may be used with meanings commonly understood by a person having ordinary skill in the art to which the present disclosure pertains. In addition, terms defined in generally used dictionaries are not to be interpreted ideally or excessively unless they are clearly and specifically defined otherwise.

Meanwhile, in describing the present disclosure, when it is determined that a detailed description of a related known function or configuration may unnecessarily obscure the gist of the present disclosure, the detailed description thereof will be omitted. In addition, the terminology used herein is terminology used to properly describe embodiments of the present disclosure, and may vary depending on the intent of a user or operator or on custom in the field to which the present disclosure pertains. Accordingly, the definitions of such terms should be made based on the contents throughout this specification.

In various embodiments described below, a campaign may be a concept including an advertisement, but is not limited to specific advertisement data. According to an embodiment, campaign information may be referred to as scenario data, and the scenario data may include at least one of text, an image, a video, and an animation.

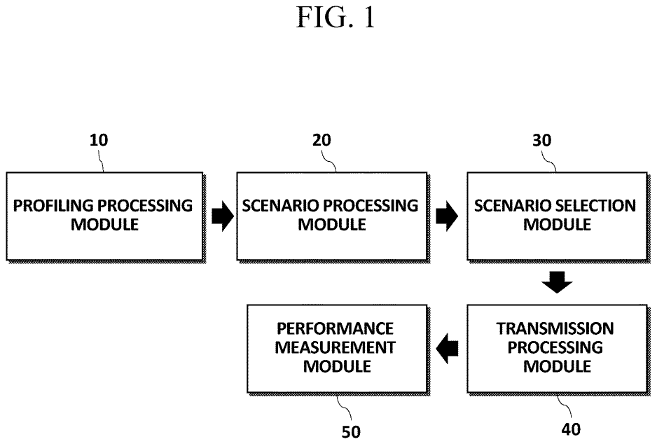

FIG. 1 is a block diagram illustrating a detailed configuration of a system for automatically generating an optimal message for each customer in a multi-campaign environment according to an embodiment of the present disclosure.

Referring to FIG. 1, the system for automatically generating an optimal message for each customer in a multi-campaign environment according to an embodiment of the present disclosure may include a profiling processing module 10, a scenario processing module 20, a scenario selection module 30, a transmission processing module 40, and a performance measurement module 50.

The profiling processing module 10 may generate profiling based on behavioral data on a browser and metadata of a customer company. For example, the behavioral data on the browser may include at least one of a page uniform resource locator (URL), an item exposure count, cart information, purchase information, and scroll information. The metadata of the customer company may include at least one of purchase history, member information, and promotion information. The profiling processing module 10 may calculate profiling based on information of the customer company itself (for example, metadata of the customer company) and behavioral information of each customer (for example, behavioral data on the browser). According to an embodiment, the profiling may include at least one of an interest level in a specific item, an interest level in a specific category, a purchase probability, and a revisit probability. The profiling may be calculated according to a known calculation method.

The profiling processing module 10 may generate profiling result data according to the profiling generation process. In this case, the profiling result data may include goal-oriented profiling data. For example, the goal-oriented profiling data may be generated by automatic tuning based on profiling parameters derived from a marketing action and performance thereof. The profiling result may be generated for each date and/or for each time. The profiling result may include individual profiling data, and may further include a target and information regarding a subsequent marketing action.

According to an embodiment, the scenario processing module 20 may generate a plurality of scenario data based on the profiling result data generated by the profiling processing module 10.

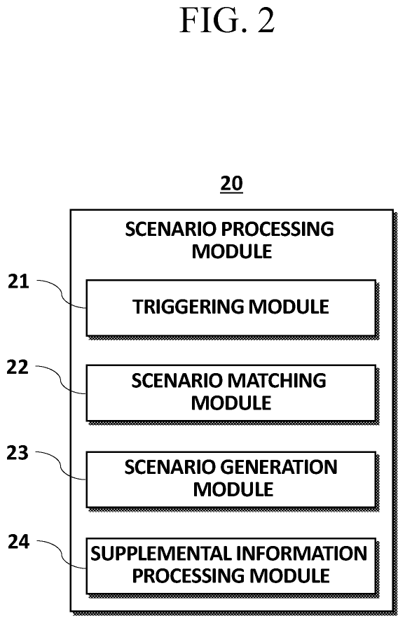

Hereinafter, the scenario processing module 20 will be described in detail with reference to FIG. 2.

FIG. 2 is a block diagram illustrating a detailed configuration of a scenario processing module according to an embodiment of the present disclosure.

Referring to FIG. 2, the scenario processing module 20 according to an embodiment may include a triggering module 21, a scenario matching module 22, a scenario generation module 23, and a supplemental information processing module 24.

According to an embodiment, the triggering module 21 may trigger simultaneous processing of batch data generation for scenario data and real-time requests for scenario data. To this end, the triggering module 21 may have a dualized architecture configured to simultaneously process the batch data generation operation and the real-time requests.

The scenario matching module 22 may select a target scenario based on a campaign execution status of a customer company, individual profiling, and performance data. For example, the campaign execution status of the customer company may include an activated marketing channel or a set time. The individual profiling and performance data may include data reflecting, for each campaign and for each period, a prior exposure status or an individual's intent (for example, turning off exposure).

The scenario generation module 23 may generate a plurality of scenario data for each individual. For example, because scenario data assigned to each individual may be selectively dropped later, the scenario generation module 23 may generate the plurality of scenario data.

The supplemental information processing module 24 may additionally generate supplemental information to be mandatorily included in a campaign. The supplemental information generated by the supplemental information processing module 24 may be attached to each of the plurality of scenario data generated by the scenario generation module 23.

Referring back to FIG. 1, according to an embodiment, the scenario selection module 30 may select final data for each individual from among the plurality of scenario data generated by the scenario processing module 20.

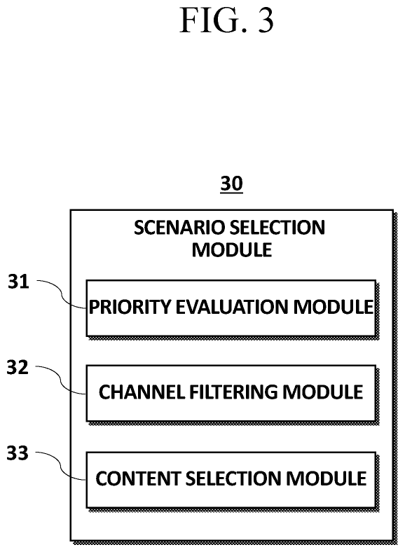

Hereinafter, the scenario selection module 30 will be described in detail with reference to FIG. 3.

FIG. 3 is a block diagram illustrating a detailed configuration of a scenario selection module according to an embodiment of the present disclosure.

Referring to FIG. 3, the scenario selection module 30 may include a priority evaluation module 31, a channel filtering module 32, and a content selection module 33.

According to an embodiment, the priority evaluation module 31 may sort a plurality of scenario data based on priority information derived from a customer company's past campaign performance. For example, the priority evaluation module 31 may select and configure a plurality of metrics, such as open rate, click-through rate, and ROAS (Return on Ad Spend), according to a campaign objective. The priority evaluation module 31 may further include response logic for a new campaign (cold start).

According to an embodiment, the channel filtering module 32 may remove unnecessary data by filtering, from among the plurality of scenario data, unnecessary data (for example, scenario data) according to settings/policies such as a channel status and cost control for each customer company. In this manner, by removing unnecessary data from among the plurality of scenario data, billing may be controlled, and overbilling and erroneous transmission may be blocked in advance.

According to an embodiment, the content selection module 33 may perform an operation of selecting content (for example, scenario data) to be actually exposed to a customer and generating final scenario data. The content selection module 33 may generate scenario data for each individual based on previously received campaign data for each customer. In this case, the content selection module 33 may apply a tracking means for measuring campaign performance.

Referring back to FIG. 1, according to an embodiment, the transmission processing module 40 may process transmission of final scenario data selected by the scenario selection module 30 for each individual and for each channel. For example, the transmission processing module 40 may process transmission of the final scenario data selected by the scenario selection module 30 by at least one means of banner, email, SMS, MMS, notification talk, channel talk, talk provided by a portal site, and app push. In this case, the transmission processing module 40 may transmit a personalized message (for example, scenario data) in real time or at a preset time. The transmission processing module 40 may determine channel status of a site by collecting indicators related to transmission itself, such as transmission success or exposure success.

According to an embodiment, the performance measurement module 50 may measure performance of a campaign. For example, the performance measurement module 50 may collect different feedback data according to characteristics of each channel. In this case, the performance measurement module 50 may collect direct response data of a recipient based on a user's open or click behavior. In addition, the performance measurement module 50 may link in-site behavioral data after the response of the recipient. In addition, the performance measurement module 50 may configure a feedback loop such that the performance measurement result is reflected back in profiling of the customer. Accordingly, the profiling processing module 10 described above may regenerate profiling of the customer based on the performance measurement result received as feedback from the performance measurement module 50.

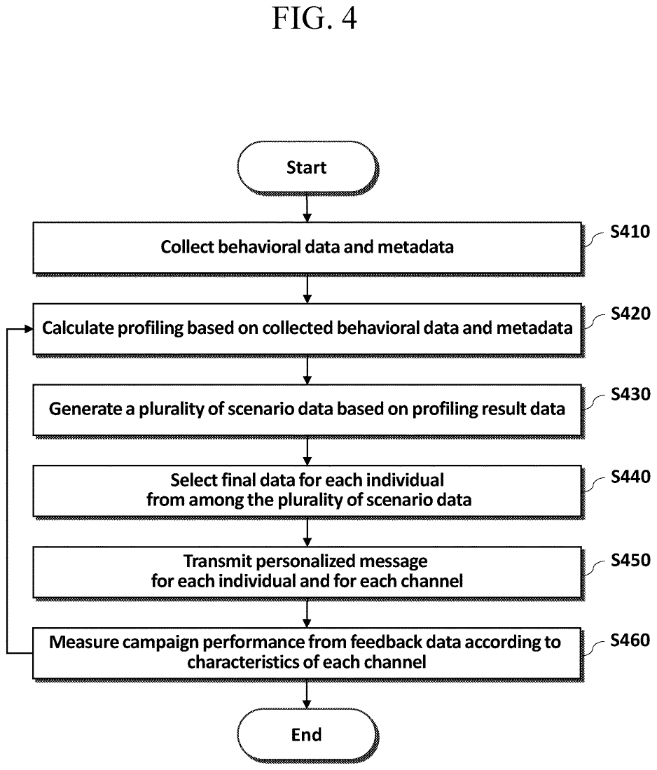

FIG. 4 is a flowchart illustrating a method for automatically generating an optimal message for each customer in a multi-campaign environment according to an embodiment of the present disclosure.

Referring to FIG. 4, according to an embodiment, the system for automatically generating an optimal message for each customer in a multi-campaign environment may first collect behavioral data on a browser and metadata of a customer company (S410). The system for automatically generating an optimal message for each customer in a multi-campaign environment may then perform a step of generating profiling based on the collected behavioral data and metadata (S420).

Next, the system for automatically generating an optimal message for each customer in a multi-campaign environment may generate a plurality of scenario data based on result data of the generated profiling (S430).

Next, the system for automatically generating an optimal message for each customer in a multi-campaign environment may select final data for each individual from among the plurality of scenario data (S440).

Next, the system for automatically generating an optimal message for each customer in a multi-campaign environment may transmit the selected final data for each individual and for each channel (S450).

Finally, the system for automatically generating an optimal message for each customer in a multi-campaign environment may measure campaign performance from feedback data according to characteristics of each channel (S460). In addition, the campaign performance measurement result may form a feedback loop such that the campaign performance measurement result is reflected back in profiling of the customer. Accordingly, profiling may be regenerated in step S420 based on the performance measurement result in step S460 received as feedback.

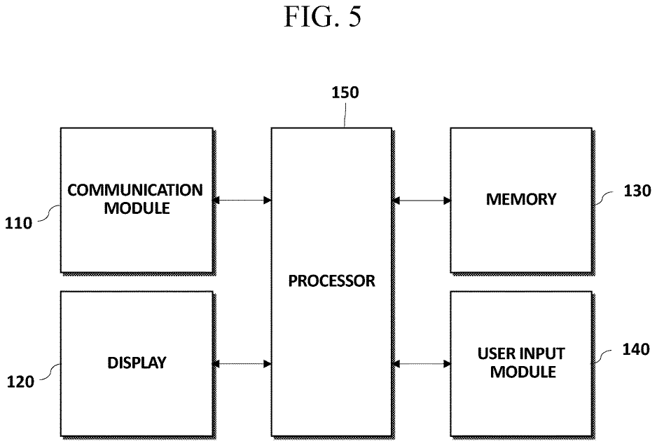

FIG. 5 is a block diagram illustrating a system for automatically generating an optimal message for each customer in a multi-campaign environment according to an embodiment of the present disclosure.

Referring to FIG. 5, the system for automatically generating an optimal message for each customer in a multi-campaign environment according to an embodiment may include a communication module 110, a display 120, a memory 130, a user input module 140, and a processor 150.

According to an embodiment, the communication module 110 may receive, from an external server, behavioral data on a browser and customer company metadata input to the profiling processing module 10. The behavioral data on the browser and the customer company metadata collected through the communication module 110 may be provided to the processor 150. The memory 130 may store the behavioral data on the browser and the customer company metadata collected through the communication module 110.

According to an embodiment, the processor 150 may process functions performed by the profiling processing module 10 shown in FIG. 1 based on the data collected through the communication module 110. For example, the processor 150 may perform functions of the respective modules shown in FIG. 1 (for example, the profiling processing module 10, the scenario processing module 20, the scenario selection module 30, the transmission processing module 40, and the performance measurement module 50).

According to an embodiment, the processor 150 may transmit, through the communication module 110, final data (for example, scenario data) for each individual and for each channel.

According to an embodiment, the user input module 140 may receive a scenario triggering request (for example, a batch data generation request and/or a real-time request) from a user. The display 120 may display, on a screen, data input during a scenario data generation process or generated data. In addition, the display 120 may display, on the screen, a performance measurement result measured by the performance measurement module 50 after transmission of a personalized scenario message.

The apparatus described above may be implemented using hardware components, software components, and/or a combination of hardware components and software components. For example, the apparatuses and components described in the embodiments may be implemented using one or more general-purpose computers or special-purpose computers, such as, for example, a processor, a controller, an ALU (arithmetic logic unit), a digital signal processor, a microcomputer, an FPA (field programmable array), a PLU (programmable logic unit), a microprocessor, or any other device capable of executing and responding to an instruction. A processing device may execute an operating system (OS) and one or more software applications executed on the operating system. In addition, the processing device may access, store, manipulate, process, and generate data in response to execution of the software. For convenience of understanding, although a single processing device may be described as being used, a person having ordinary skill in the art will appreciate that the processing device may include a plurality of processing elements and/or a plurality of types of processing elements. For example, the processing device may include a plurality of processors or a single processor and a single controller. In addition, other processing configurations, such as a parallel processor, are also possible.

Software may include a computer program, code, an instruction, or one or more combinations thereof, and may configure the processing device to operate as desired or may instruct the processing device independently or collectively. The software and/or data may be permanently or temporarily embodied in any type of machine, component, physical device, virtual equipment, computer storage medium or device, or transmitted signal wave, in order to be interpreted by the processing device or to provide instructions or data to the processing device. The software may be distributed over network-connected computer systems so as to be stored or executed in a distributed manner. The software and data may be stored in one or more computer-readable recording media.

A method according to an embodiment may be implemented in the form of program instructions executable by various computer means and recorded in a computer-readable medium. The computer-readable medium may include the program instructions, a data file, a data structure, or a combination thereof, alone or in combination. The program instructions recorded in the medium may be specially designed and configured for the embodiments, or may be known and available to those skilled in the art of computer software. Examples of the computer-readable recording medium include magnetic media such as hard disks, floppy disks, and magnetic tapes; optical recording media such as CD-ROMs and DVDs; magneto-optical media such as floptical disks; and hardware devices specially configured to store and execute program instructions, such as ROM, RAM, and flash memory. Examples of the program instructions include not only machine language code, such as that generated by a compiler, but also high-level language code executable by a computer using an interpreter or the like. The hardware devices described above may be configured to operate as one or more software modules in order to perform operations of the embodiments, and vice versa.

Although the embodiments have been described above with reference to limited embodiments and drawings, various modifications and changes may be made thereto by those skilled in the art based on the foregoing description. For example, appropriate results may be achieved even if the described techniques are performed in a sequence different from the described method, and/or components of the described system, structure, device, circuit, and the like are combined or arranged in a form different from the described method, or are replaced or substituted with other components or equivalents.

Therefore, other implementations, other embodiments, and equivalents to the appended claims are also within the scope of the following claims.

What is claimed is:

1. A system, comprising a processor, for automatically generating an optimal message for each customer in a multi-campaign environment, the system comprising:
a profiling processing module configured to generate profiling based on behavioral data on a browser and metadata of a customer company;
a scenario processing module configured to generate a plurality of scenario data based on result data of the generated profiling;
a scenario selection module configured to select final data for each individual from among the plurality of scenario data; and
a transmission processing module configured to transmit a message to each individual by each channel based on the selected final data for each individual.

2. The system of claim 1, wherein the behavioral data on the browser include at least one of a page uniform resource locator (URL), an item exposure count, cart information, purchase information, and scroll information.

3. The system of claim 1, wherein the metadata of the customer company include at least one of purchase history, member information, and promotion information.

4. The system of claim 1, wherein the profiling includes at least one of an interest level in a specific item, an interest level in a specific category, a purchase probability, and a revisit probability.

5. The system of claim 1, wherein the scenario processing module comprises a triggering module configured to trigger simultaneous processing of batch data generation for scenario data and real-time requests for scenario data.

6. The system of claim 1, wherein the scenario processing module comprises a scenario matching module configured to select a target scenario based on a campaign execution status of the customer company, individual profiling, and performance data.

7. The system of claim 1, wherein the scenario processing module comprises a scenario generation module configured to generate a plurality of scenario data for each individual.

8. The system of claim 1, wherein the scenario processing module comprises a supplemental information processing module configured to additionally generate supplemental information to be mandatorily included in a campaign.

9. The system of claim 1, wherein the scenario selection module comprises:
a priority evaluation module configured to sort scenario data based on priority information derived from past campaign performance of the customer company;
a channel filtering module configured to remove unnecessary data based on a channel status for each customer company; and
a content selection module configured to select one of scenario data from the filtered plurality of scenario data.

10. The system of claim 1, further comprising a performance measurement module configured to collect different feedback data according to characteristics of each channel and measure performance of a campaign.

11. A method for automatically generating an optimal message for each customer in a multi-campaign environment, the method comprising:
generating profiling based on behavioral data on a browser and metadata of a customer company;
generating a plurality of scenario data based on result data of the generated profiling;
selecting final data for each individual from among the plurality of scenario data; and
transmitting a message to each individual by each channel based on the selected final data for each individual.

12. The method of claim 11, wherein the behavioral data on the browser include at least one of a page uniform resource locator (URL), an item exposure count, cart information, purchase information, and scroll information.

13. The method of claim 11, wherein the metadata of the customer company include at least one of purchase history, member information, and promotion information.

14. The method of claim 11, wherein the profiling includes at least one of an interest level in a specific item, an interest level in a specific category, a purchase probability, and a revisit probability.

15. The method of claim 11, wherein generating the scenario data comprises triggering simultaneous processing of batch data generation for scenario data and real-time requests for scenario data.
